(19) United States
(12) Patent Application Publication
(10) Pub. No.: US 2012/0007371 A1
(43) Pub. Date: Jan. 12, 2012

(54) Fuel Cell System Comprising at Least One Fuel Cell

(75) Inventors: Gerhard Konrad, Ulm (DE); Felix Sterk, Schlier (DE)

(73) Assignee: Daimler AG, Stuttgart 70327 (DE)

(21) Appl. No.: 13/202,205

(22) PCT Filed: Jan. 27, 2010
(86) PCT No.: PCT/EP2010/000474

§ 371 Date: Sep. 29, 2011

(30) Foreign Application Priority Data
Feb. 19, 2009 (DE) 10 2009 009 674.4

(51) Int. Cl. H01M 8/06; H02K 7/18; F01K 27/00

(52) U.S. Cl. 290/1 R; 429/414; 60/685

(57) ABSTRACT

A fuel cell system comprises a fuel cell with a cathode region and anode region. The fuel cell system includes an exchanging device, which is flown through by an intake air flow flowing to the cathode region and by a used air flow discharged from the cathode region. In the exchanging device, heat is transferred from the intake air flow to the used air flow, and water vapor is simultaneously transferred from the used air flow to the intake air flow. At least part of the exchanging device is provided with a catalytic material at the intake air side. Furthermore, an exhaust gas from the anode region is fed to the exchanging device at the intake air side.

### BACKGROUND AND SUMMARY OF THE INVENTION

The invention relates to a fuel cell system comprising at least one fuel cell.

A generic fuel cell system is described in German patent document DE 10 2007 003 144 A1. The fuel system comprises an exchanging device, which combines the two functions “cooling” and humidification“. The exchanging device, referred to as a function unit in that document, permits a material flow from the used air of the fuel cell to the intake air to the fuel cell, while a heat exchange from the intake air heated by a compression device to the comparatively cool exhaust air likewise takes place.

German patent document DE 101 15 336 A1 discloses a fuel cell system, though not one with a device which is formed comparable to the function unit or the exchanging device of the above-mentioned document. DE 101 15 336 A1, however, concerns the handling of hydrogen-containing exhaust gas, which has to be emitted from time to time from the region of the anode cycle with a cycle guidance of the anode gases. The hydrogen-containing gas is introduced into the region of the intake air to the cathode region of the fuel cell so that this reacts together with the oxygen of the intake air at a catalyst, particularly at the catalyst that is present in any case in the region of the cathode.

This dosing of hydrogen-containing exhaust gas from the anode region of the fuel cell has a negative effect on the conditioning of the intake air to the cathode region of the fuel cell with regard to the temperature developed during the reaction. If the reaction is additionally permitted in the region of the catalyst at the cells themselves, a quicker ageing of the fuel cells is effected. The construction thus has the disadvantage that it is very restricted in its use, particularly also with regard to the convertible amount of hydrogen-containing exhaust gas, in order to avoid the above-mentioned disadvantages from becoming too large. The use is thus afflicted with decisive disadvantages and, due to the restriction of the hydrogen-containing exhaust gas with regard to amount, in order to minimize the disadvantages, is restricted to the use in a construction with an anode recirculation cycle.

Exemplary embodiments of the present invention provide an improved fuel cell system in that a conversion of hydrogen-containing exhaust gases is enabled, which can beneficially be used in a fuel cell system, and which avoids the above-mentioned disadvantages.

By the arrangement of catalytic material in the intake air side of the exchanging device, the exhaust gas from the anode region is converted in the exchanging device. This has the advantage that a special catalyst can be used in the exchanging device, and a reaction of hydrogen and oxygen in the cathode region is thus omitted. The negative influences on the ageing of the fuel cell can thereby be avoided. The conditioning of the intake air to the cathode region of the fuel cell additionally takes place in the exchanging device. The supply of exhaust gas from the anode region into the exchanging device thus has no or no non-correctable influence on the intake air flowing from the exchanging device to the cathode region of the fuel cell. In the region of the catalytic material the temperature of the intake air is increased, as it is, however, first cooled in the region of the exchanging device before it continues to flow to the cathode region, it has no negative influence on the intake air. Rather, the heat will further heat the used air flow cooling the intake air. This can have a decisive advantage, if, for example, the heat from the used air flow shall be used in a different manner, or if a discharge of liquid water with the used air flow from the fuel cell system shall be prevented.

Additionally, a certain amount of water or water vapor results with the conversion of the hydrogen-containing exhaust gas in the region of the catalytic material in the exchanging device. This provides, together with the water vapor transferred from the used air flow to the intake air flow through the exchanging device, a humidification of the fuel cell or of polymer electrolyte membranes (PE membranes) typically used in such a fuel cell, which separate the cathode region from the anode region and provide the function of the fuel cell in a known manner.

In a particularly favorable arrangement of the fuel cell system according to the invention, the supply of exhaust gas from the anode region takes place in a controlled and/or regulated manner. Particularly with the use of a fuel cell system with a recirculation of anode exhaust gas, the temporal and/or the quantitative supply of exhaust gas from the anode region into the intake air side of the exchanging device can be controlled or regulated within certain limits. Thereby, the supply of the exhaust gas into the exchanging device can be delayed at an unfavorable time, where, for example, no sufficient used air flow is available for cooling the resulting heat. Unfavorable operating states can thus be avoided and an improved operating guidance can be realized for the fuel cell system.

In a further particularly favorable arrangement of the fuel cell system according to the invention, a fuel, particularly hydrogen, can be supplied to the exchanging device on the intake air side. By this supply of an optional fuel, particularly of the hydrogen present in any case in the fuel cell system, a further flexibilization of the fuel cell system can be achieved. Such a supply of further fuel into the region on the intake air side of the exchanging device, and thus into the region of the catalytic material, can always take place if a higher humidity amount is required, as the supplied fuel reacts with the oxygen to water vapor. Such an optional supply can additionally take place when a larger heat amount is required in the used air flow, for example with a use of the exhaust heat, or for the evaporation of a larger amount of liquid water in the used air flow, which shall not leave the system in liquid form.

In a particularly favorable and advantageous further development of the fuel cell system according to the invention, the intake air is supplied via a compressor arranged downstream of the exchanging device, wherein the compressor can be driven by a turbine at least in a supporting manner, through the used air downstream of the exchanging device is passed. This construction with a turbine, which drives the compressor at least in a supporting manner in the manner of a turbocharger customary with internal combustion engines, permits use of the used heat in the used air flow together with the remaining pressure energy. If additional heat is now introduced into the used air flow by the construction of the fuel cell system according to the invention, this can again be converted back to mechanical energy, so that the fuel cell system altogether has less parasitic energy usage, and thus permits a higher efficiency.

The fuel cell system according to the invention thus provides a simple, compact and thus cost-efficient construction, with an ideal arrangement for the life span and the efficiency that can be achieved. The fuel cell system according to the invention is thus particularly suitable for the use in a means of transport, and here for the generation of power for the drive and/or electrical auxiliary users in the means of transport. A means of transport in the sense of the invention present can be any type of means of transport on land, on water or in the air, wherein a particular attention is certainly in the use of these fuel cell systems for motor vehicle without rails, without the use of a fuel cell system according to the invention being restricted hereby.

Further advantageous arrangements of the fuel cell system will become clear by means of the exemplary embodiments, which are described in more detail in the following with reference to the figures.

### BRIEF DESCRIPTION OF THE DRAWING FIGURES

It shows thereby:

FIG. 1 a first possible embodiment of the fuel cell system according to the invention; and

FIG. 2 a further alternative embodiment of the fuel cell system according to the invention.

### DETAILED DESCRIPTION

The depiction in the following figures only shows the components necessary for the understanding of the invention of the rather complex fuel cell system per se present here in a highly schematized depiction. It should be understood for the fuel cell system that further components, as for example a cooling cycle and the like are also provided in the fuel cell system, even though these are not illustrated in the figures.

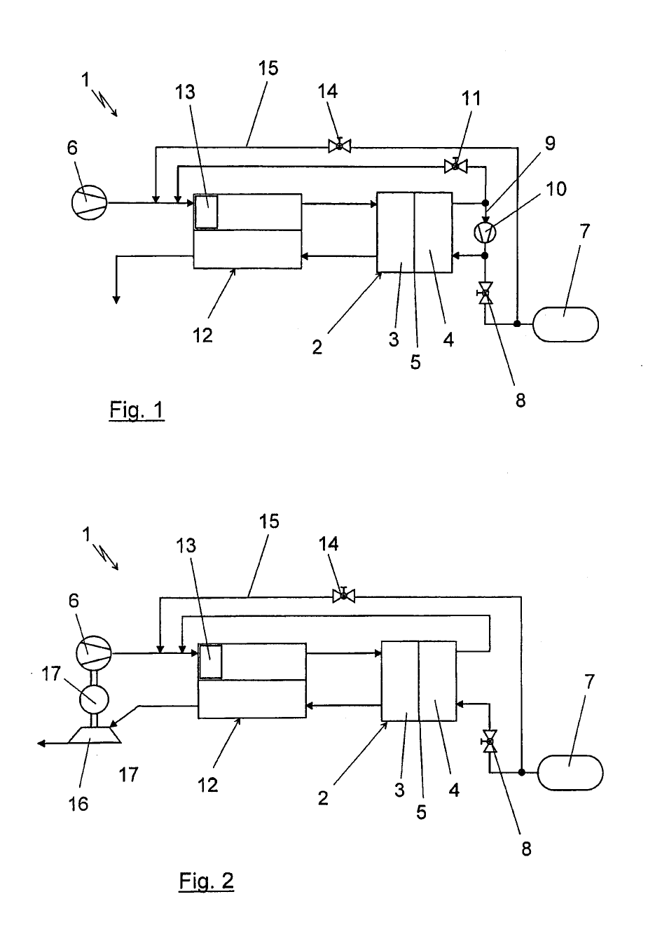

In FIG. 1, a fuel cell system 1 comprising a fuel cell 2 is now shown. The fuel cell 2 includes a stack of individual cells constructed in a customary manner. A cathode region 3 and an anode region 4 is formed in the fuel cell, which regions are separated from each other by a PE membrane 5 in the exemplary embodiment shown here. In the exemplary embodiment shown in FIG. 1, an intake air flow is supplied to the cathode region 3 via a compressor 6. The compressor 6 can, for example, be designed as a screw compressor or as a flow compressor, as is customary with fuel cell systems. Basically, other possibilities for compressing the supplied air flow are however also conceivable, for example, by a piston machine or the like. The intake air flow fed to the cathode region 3 reacts to water with the hydrogen fed to the anode region 4 in the fuel cell 2, whereby electrical power is released. This principle of the fuel cell 2 known per se only has a subordinate role for the present invention, which is why it shall not be explained in more detail.

Hydrogen from a hydrogen storage device 7, for example, a pressure gas store and/or a hydride store, is supplied to the anode region 4 in the exemplary embodiment shown here. It would also be possible to supply the fuel cell 2 with a hydrogen-containing gas, which is for example generated from hydrocarbon-containing start materials in the region of the fuel cell system.

In the exemplary embodiment of FIG. 1, the hydrogen from the hydrogen storage device 7 is guided into the anode region 4 via a dosing device 8, only indicated schematically here. The exhaust gas flowing from the anode region 4, which gas generally still contains a comparatively high amount of hydrogen, is fed back into the anode region 4 via a recirculation line 9 and a recirculation feed device 10. In the region of this recirculation, fresh hydrogen discharged from the hydrogen storage device 7 is supplied, so that a sufficient amount of hydrogen is always available in the anode region 4. The construction of the anode region 4 of the fuel cell 2 with the recirculation line 9 and the recirculation feed device 10 is known per se and customary. A gas jet pump can, for example, be used as recirculation feed device 10, which pump is driven by the fresh hydrogen discharged from the hydrogen storage device 7. A recirculation blower would alternatively also be possible as recirculation feed device 10. Combinations of these different feed device are naturally also possible, which shall also be included in the definition of the recirculation feed device 10 according to the present description here. It is additionally known with the use of a recirculation of anode exhaust gas, that inert gases, as for example nitrogen, accumulate over time in the region of the recirculation line 9, which gases reach the anode region 4 from the cathode region 3 through the PE membrane 5. In order to be able to further provide a sufficient concentration of hydrogen in the anode region 4, it is thus necessary to discharge the exhaust gas of the anode region in the recirculation line from time to time. For this, a discharge valve 11 is provided in the exemplary embodiment according to FIG. 1, through which valve the exhaust gas from the anode region 4 can be discharged from time to time. This process is often also called “purge”. The exhaust gas thereby always also contains a corresponding amount of residual hydrogen in addition to the inert gases.

The intake air flowing from the compressor 6 to the cathode region 3 flows through an exchanging device 12 in the construction of the fuel cell system 1 according to FIG. 1, in which exchanging device the conditioning of the intake air takes place. The intake air will typically have a comparatively high temperature behind the compressor 6. As the fuel cell 2, and here particularly the PE membranes 5 of the fuel cell 2, react sensitively to a temperature that is too high and to gases which are too dry, the intake air in the exchanging device 12 is correspondingly cooled and humidified. For the cooling and the humidifying, the used air flow coming from the cathode region 3 is used. This also flows through the exchanging device 12. The exchanging device 12 is constructed in such a manner that it basically separates the two material flows of the intake air and the used air. This can, for example, take place in that one of the material flows flows through hollow fibers, while the other one of the material flows flows around the hollow fibers. It would additionally be possible to construct the exchanging device 12 in the manner of a plate reactor, where the two material flows are separated from each other by planar plates or membranes.

It has proved to be particularly advantageous to construct the exchanging device 12 in the form of a honeycomb body, as is, for example, customary with exhaust gas catalysts of motor vehicles. A corresponding arrangement of the honeycomb body provides that the intake air flow and the used air flow flow in different adjacent channels of the honeycomb body. Any type of flow-through is thereby basically possible, for example, a co-current flow guidance or a cross flow guidance of the two material flows. It has, however, shown to be particularly suitable to guide the material flows through the exchanging device 12 in a counterflow or a flow guide with a high counterflow part. A heat exchange of the hot intake air flow to the cold used air flow of the cathode region 13 results now in the exchanging device 12. By means of a counterflow guidance the coldest used air flow is in heat-conductive contact with the part of the intake air flow that is already cooled the most, while the used air flow that is already heated to a large extent cools the intake air flow which is still very hot during the inflow into the exchanging device 12. A very good cooling of the intake air flow is achieved. The material of the exchanging device, for example temperature-resistant membranes, porous ceramics, zeolites or the like, permits a passage of water vapor from the very humid used air flow of the cathode region 3, which entrains the product water resulting in the fuel cell 2, into the region of the very dry intake air flow to the cathode region 3. The intake air flow is humidified correspondingly thereby, which has a positive effect on the function and the life span of the PE membranes 5 in the region of the fuel cell 2. Thus is the construction and the function of the exchanging device 12 also already known from DE 10 2007 003 144 A1 already mentioned at the outset.

In the exemplary embodiment present here, the exchanging device 12 additionally has a catalytic material in addition to its construction according to the state of the art. This catalytic material, which shall be symbolized in the depiction by the region 13, serves for the reaction of hydrogen with the oxygen in the intake air. The hydrogen thereby comes from the recirculation line 9 around the anode region 2 of the fuel cell 2. It is, as already mentioned, discharged from time to time via the discharge valve 11. This hydrogen-containing exhaust gas, which is also called purge gas, now reaches the exchanging device 12 on the used air side. The exhaust gas or the hydrogen contained in the exhaust gas can react there with a part of the residual oxygen in the used air in the region of catalytic material 13. Heat and water in the form of water vapor result. The water vapor is particularly advantageous here, as it supports the humidification of the intake air flow and thus the humidification of the cathode region of the fuel cell. The resulting heat is not desired in the region of the intake air. By means of the construction of the exchanging device 12, it can, however, be transferred directly to the used air flow from the cathode region 3 of the fuel cell 2 and increases its temperature compared to an exchanging device 12 without the catalytic material and the supply of exhaust gas from the anode region in addition. This, however, does not pose a disadvantage with the emission of the used air to the environment, as a comparatively warm used air is desired in order to discharge the water still contained in the used air to the environment in the form of water vapor and thus to prevent the discharge of liquid water together with the used air.

The catalytic material 13 can be introduced on the intake air side into the exchanging device 12, for example, in the form of a ballasting of catalytically active parts. It is, however, particularly advantageous if the exchanging device 12 is coated with the catalytic material 13 in its region on the intake air side. It is thereby basically possible to coat the entire surface of the exchanging device 12 on the intake air side with the catalytic material 13. It thereby only has to be observed that the coating with the catalytic material does not hinder the transfer of the water vapor from the used air to the intake air. This can, however, be achieved by a corresponding pore size or the like in the coating with catalytic material 13. Alternatively, the catalytic material 13 can be arranged only in the intake air side region of the exchanging device 12, that is, in the region in which the intake air flows from the compressor 6 into the exchanging device 12. The region is thereby meant to be a certain section of the intake air side of the exchanging device 12, for example a region of about 1/8 to 1/4 of the exchanging surface of the exchanging device 12. With such a construction it would then be possible that a material exchange between the two flows can be omitted in the region of the catalytic material 13. The remaining region of the exchange surface would be sufficient to transfer a correspondingly high amount of water vapor from the used air to the intake air. The region with the catalytic material 13 would then only serve for the catalytic reaction of the hydrogen present in the exhaust gas of the anode region 4 and for the transfer of the heat resulting thereby to the used air flow flowing from the exchanging device 12.

Additionally, a further fuel can be supplied to the exchanging device 12 on the used air side. This could be hydrogen with the hydrogen present in the fuel cell system 1 in any case. It is, however, also conceivable to supply a hydrocarbon or the like, if this would be available in the fuel cell system 1. The supply of the additional hydrogen takes place in the exemplary embodiment of the fuel cell system 1 shown here from the region of the water storage device 7 via a dosing device 14 and a corresponding guidance element 15. The optional hydrogen can, as also the exhaust gas from the anode region 4, be introduced either into the feed line of the intake air in front of the exchanging device 12, as is indicated in principle by FIG. 1. Alternatively, it would of course also be possible to introduce the exhaust gas and/or the hydrogen directly into the exchanging device 12, and here particularly in the region of the catalytic material 13. The additional hydrogen can now be used to generate additional water vapor in the region of the catalytic material 13. This additional water vapor can be used in certain operating states In order to improve the humidification of the intake air flow, and thus to prevent a drying of the PE membranes 5 of the fuel cell 2. Alternatively, it can also be provided to influence the heat resulting in the exchanging device 12 correspondingly via the optional additional supply of hydrogen, so that the used air can, for example, be heated in a defined manner in certain situations, in order to use its present exhaust heat correspondingly and/or to avoid the discharge of liquid water with the used air flow.

The construction of the fuel cell system 1 according to FIG. 1 could additionally have a controllable or regulatable bypass, not shown here, around the exchanging device 12. The bypass could be arranged on the intake air side and also on the used air side. It would allow passing a part of the material flow around the exchanging device 12, in order to mix this again with the original material flow in the case of the intake air or otherwise used air is still required behind the exchanging device. A humidifying degree can thereby be adjusted in a very defined manner, or a humidification could be avoided in situations where it is not desired. As such a bypass is, however, known in the state of the art with humidifiers, it shall not be discussed here in detail.

FIG. 2 shows an alternative embodiment of the fuel cell system 1. The same components are provided with the same reference numerals and have a comparable functionality as the analogous components in FIG. 1. Thus, only the differences of the fuel cell system 1 according to FIG. 2 compared to the one described up to now are discussed in the following. The fuel cell system 1 of FIG. 2 has essentially two differences compared to the fuel cell system 1 of FIG. 1. The first difference is that the exhaust gas from the anode region 4 is not guided in a cycle, but that this exhaust gas flows directly into the exchanging device 12 on the intake air side. The fuel cell 2 is thus not operated with an anode cycle in the exemplary embodiment of FIG. 2, but with an anode, which is only flown through by hydrogen, wherein a certain excess of hydrogen discharges again from the anode region 4 as exhaust gas. This construction, which is also known in the state of the art, is generally combined with a division of the anode region into different active partial regions, wherein the successive partial region in the flow direction have decreasing active surfaces, so that the remaining hydrogen flow can largely be converted, without having to provide an unused active surface. With the use of such a cascaded anode region 4, it is thereby possible with the supply of the fuel cell with pure hydrogen from the hydrogen storage device 7, to drive with a very low excess of hydrogen of only 3-5%. This excess of hydrogen is then discharged from the anode region 4 as exhaust gas and reaches the exchanging device 12 and here into the region of the catalytic material 13 on the intake air side. A comparable conversion of the hydrogen now results as already described with the exemplary embodiment according to FIG. 1, with all options already mentioned there.

The second difference of the fuel cell system 1 of FIG. 2 is that the used air flows through a turbine 16 arranged after the exchanging device 12 and thereby emits the pressure energy and particularly the exhaust heat contained therein to a large part to the turbine 16. The turbine 16 is coupled directly or indirectly to the compressor 6, so that energy occurring in the turbine 16 can be used for operating the compressor 6. As the energy supplied via the turbine 16 will not be sufficient in most of the operating states to operate the compressor 6, it is additionally coupled to an electrical machine 17. Additional drive energy for the compressor can be provided via this electrical machine 17. If an excess of power should result in the turbine 16 in certain operating states, the turbine can drive not only the compressor 6 but also the electrical machine as a generator in this case. The electrical power then generated by the electrical machine 17 can then be used or stored in the fuel cell system 1 in another manner. This construction of a so-called turbocharger is also known in the state of the art with fuel cell systems.

A particular advantage now results in that the exhaust heat present in the used air can now be used via the turbine 16. The heating with the catalytic reaction of exhaust gas from the anode region with oxygen in the intake air flow perceived as very problematic up to now can be used in a beneficial manner with this construction, as the heat transferred to the used air can now be used in the turbine 16 and be converted to mechanical energy.

The construction of the fuel cell system according to FIG. 2 thus permits a beneficial use thereof by the active use of the exhaust heat resulting in the region of the catalytic material 13. Thereby, the amount of residual hydrogen due to thermal reasons or ageing reasons or system-technical reasons is thereby no longer restricted, as in the state of the art. It is, in fact, sensible to convert as much hydrogen as possible in the fuel cell 2, but the construction of the fuel cell system 1 according to FIG. 2 permits, however, to possibly also convert larger amounts of residual hydrogen in the region of the catalytic material 13 in the exchanging device 12. This enables in the first instance a foregoing of the anode recirculation. Also, a defined operation of the turbine 16 by means of the exhaust heat resulting in the region of the catalytic material 13 can now be carried out by the optional addition of fuel via the dosing device 14 and the guide element 15 already mentioned above. In certain operation situations, it can definitely be sensible to introduce additional hydrogen into the region of the catalytic material 13 in the exchanging device 12, not only due to reasons of humidification, but also due to reasons of the exhaust heat in the used air flow needed for the turbine 16. An example for such a situation could be that an increased power is abruptly demanded by the fuel cell 2, which results in a correspondingly increased power of the compressor 6. In such a case, a larger power could be provided at the turbine 16 via an increase of the exhaust heat amount in the used air flow, which at least aids in covering the power demand of the compressor 6 in this situation. Additional water vapor simultaneously results in the region of the exchanging device, which improves the humidification, namely exactly when a power peak is demanded by the fuel cell, without a corresponding large amount of humid used air being available for humidifying the intake air.

It shall finally be noted that the fuel cell system 1 according to the arrangement of FIG. 2 can also have further components, which are generally known and customary. A bypass around the exchanging device 12 shall be mentioned here again in an exemplary manner, which could be used in an analogous manner to the above-described construction. A water separator can additionally be provided in the region between the exchanging device 12 and the turbine 16 in the used air flow, in order to prevent that liquid droplets reach the region of the turbine 16 and possibly damage components thereof. Otherwise, the two embodiments can of course be combined among each other by a simple exchange of parts of the described fuel cell systems. It would thus, for example, be conceivable to combine the construction with the turbine 16 with the construction of the recirculation line 9. It would also be conceivable to forego the turbine 16 in a fuel cell system 1 as represented by FIG. 2.

1-12. (canceled)

13. A fuel cell system, comprising:
at least one fuel cell with a cathode region and an anode region;
an exchanging device arranged to receive an intake air flow flowing to the cathode region and a used air flow discharged from the cathode region, wherein, in the exchanging device, heat is transferred from the intake air flow to the used air flow and water vapor is simultaneously transferred from the used air flow to the intake air flow,
wherein at least part of the exchanging device includes a catalytic material at an intake air side, and an exhaust gas from the anode region is fed to the exchanging device at the intake air side.

14. The fuel cell system according to claim 13, wherein the exhaust gas from the anode region is supplied in a controlled or regulated manner.

15. The fuel cell system according to claim 13, wherein hydrogen is supplied to the exchanging device on the intake air side.

16. The fuel cell system according to claim 13, wherein the catalytic material is a coating in the intake air side of the exchanging device.

17. The fuel cell system according to claim 13, wherein the exchanging device has an at least partially a honeycomb structure.

18. The fuel cell system according to claim 13, wherein the exchanging device is flown through essentially in a counterflow manner, wherein the catalytic material is arranged in a region in which the intake air and the exhaust gas flow into the exchanging device and in which the used air flows from the exchanging device.

19. The fuel cell system according to claim 13, wherein the anode region is flown through by hydrogen or hydrogen-containing gas, wherein an output of the anode region is connected to an input of the exchanging device on the intake air side.

20. The fuel cell system according to claim 19, wherein the anode region includes several sections connected in series, each of the several sections has an active surface in a flow direction of the hydrogen or of the hydrogen-containing gas in the anode region that is respectively smaller than an active surface of a previous section.

21. The fuel cell system according to claim 20, wherein the anode region is flown through by hydrogen, wherein the output of the anode region is connected to an input of the anode region via a recirculation line and a feed device, wherein the recirculation line is connected to the input of the exchanging device on the intake air side via a switchable valve device.

22. The fuel cell system according to claim 13, wherein intake air is fed via a compressor arranged upstream of the exchanging device, wherein the compressor is coupled to a turbine that drives the compressor in at least a supporting manner, wherein the turbine is flown through by the used air downstream of the exchanging device.

23. The fuel cell system according to claim 22, wherein the compressor is driveable by an electrical machine, wherein the turbine drives the electrical machine in a generator manner for generating electrical power with a power excess at the turbine.

24. A method of using a fuel cell system comprising at least one fuel cell with a cathode region and an anode region and an exchanging device, the method comprising:
receiving, by the exchanging device, an intake air flow flowing to the cathode region;
receiving, by the exchanging device, a used air flow discharged from the cathode region, wherein, in the exchanging device, heat is transferred from the intake air flow to the used air flow and water vapor is simultaneously transferred from the used air flow to the intake air flow,
feeding an exhaust gas from the anode region to the exchanging device at an intake air side, wherein at least part of the exchanging device includes a catalytic material at the intake air side.
